(19) United States
(12) Patent Application Publication
(10) Pub. No.: US 2006/0022177 A1
(43) Pub. Date: Feb. 2, 2006

(54) Nanoparticulate organc uv absorber

(76) Inventor: Martin Koenemann, (US)

Correspondence Address: NOVAK DRUCE DELUCA & QUIGG, LLP, 1300 EYE STREET NW, SUITE 400 EAST, WASHINGTON, DC, 20005, US

(21) Appl. No.: 10/509,636

(22) PCT Filed: Apr. 9, 2003
(86) PCT No.: PCT/EP03/03692

§ 371 Date: Sep. 29, 2004

(30) Foreign Application Priority Data
Apr. 10, 2002 (DE) 10215752.9

(51) Int. Cl. C09K 15/20; F21V 9/06

(52) U.S. Cl. 252/588; 252/403

(57) ABSTRACT

The present invention relates to a UV absorber which comprises a finely divided polymer with a volume-average particle size of from 5 to 1 000 nm, to a process for its preparation, and to its use for stabilizing molding compositions and coating films and as a light protection factor in cosmetic formulations.

The present invention relates to a UV absorber which comprises a finely divided polymer, to a process for its preparation, and to its use.

Inanimate organic materials, such as molding compositions or coating films, suffer deterioration under the effect of UV radiation e.g. in sunlight, e.g. embrittlement, color change or stress corrosion cracking. They are therefore usually protected by the inclusion of UV absorbers (also called UV stabilizers in the text below). Substances which are used as UV stabilizers should be distributed as finely as possible in the application media in order to develop a uniform protective action. Fine distribution in transparent media is particularly important since otherwise incident light is scattered. However, if the substance is molecularly soluble in the application medium and thus “distributed” as best as possible, this is often associated with undesired migration behavior and the substance escapes relatively readily from the material. This phenomenon is referred to as “exudation”.

In cosmetic formulations, UV absorbers are used in order to protect the human skin against the harmful effect of natural UV radiation. Soluble UV absorbers can, however, diffuse through the skin to an undesired degree. Pigmentary UV absorbers, such as titanium dioxide or zinc oxide, have the disadvantage that they back-scatter the incident light as white light, which, particularly in the case of darkly pigmented skin, may lead to an undesired visible white film of light protection agent.

U.S. Pat. No. 3,230,196 describes polybenzoxazols and a process for their preparation by condensation of aminohydroxybenzoic acids or of bis(o-aminophenols) with aromatic dicarboxylic acids. These polymers are also said to be useful as UV absorbers. However, the specification does not give any more details as to how the polybenzoxazols should be prepared for use as UV absorbers.

It is an object of the present invention to provide a UV absorber which, when used in transparent media or cosmetic formulations, does not scatter incident light and at the same time has favorable migration behavior.

We have found that this object is achieved by a UV absorber comprising a finely divided polymer with a volume-average particle size of from 5 to 1 000 nm which contains repeat units of the formula I and/or II 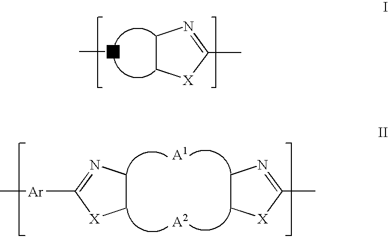
in which
X is NH, O or S, preferably O,
A or A¹ and A² together with the carbon atoms to which they are bonded form an aromatic backbone with one to three fused benzene rings or a diaryl backbone which can carry one to three substituents chosen from carboxyl, alkyl, alkenyl, aryl, alkylaryl, alkoxy, halogen or nitro, or a polymer chain containing repeat units of the formula I and/or II,
Ar is a divalent aromatic radical with one to three fused benzene rings or a diaryl radical which can carry one to three substituents chosen from carboxyl, alkyl, alkenyl, aryl, alkylaryl, alkoxy, halogen or nitro.

Preferably, the polymer has a volume-average particle size of from 10 to 500 nm, particularly preferably from 20 to 100 nm and in particular from 20 to 60 nm.

The term “aromatic backbone with one to three fused benzene rings” preferably represents benzene or naphthalene;

“diaryl radical” preferably represents diphenyl;

“carboxyl” represents COOH or salts thereof, in particular containing alkali metal cations, such as sodium or potassium, or ammonium ions;

“alkyl” (also in composite words such as “alkylaryl” or “alkoxy”) preferably represents C₁-C₆-alkyl, such as methyl, ethyl, t-butyl;

“alkenyl” preferably represents C₂-C₄-alkenyl, such as vinyl or allyl;

“aryl” preferably represents phenyl;

“halogen” preferably represents fluorine or chlorine.

In the repeat units of the formula II, the two nitrogen atoms can adopt any orientation relative to one another; i.e. the depicted formula II is also intended to include the positional isomer IIa

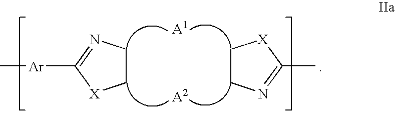

Preferred repeat units I are: 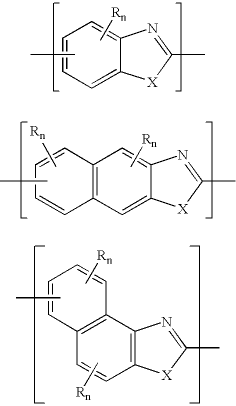
in which n, independently, is 0, 1 or 2 and R, independently, is carboxyl, alkyl, alkenyl, aryl, alkylaryl, alkoxy, halogen or nitro or a polymer chain containing repeat units of the formula I and/or II.

Preferred repeat units II are those in which —Ar— is chosen from 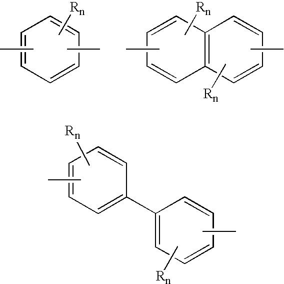
and the unit 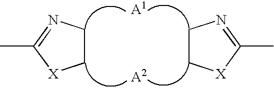
is chosen from 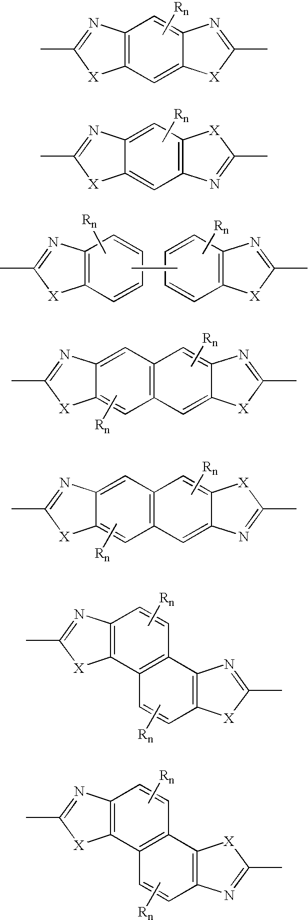
where R and n have the meanings already given.

The polymer preferably contains at least 1 mol %, particularly preferably at least 20 mol % and in particular at least 30 mol %, based on the sum of the repeat units of the formula I and twice the repeat units of the formula II, of repeat units of the formulae I.a and/or I.b, 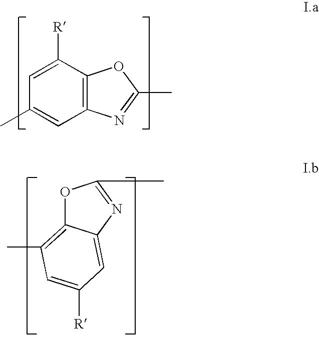
where R′ is carboxyl or a polymer chain containing repeat units of the formula I and/or II. Polymers in which at least some of the radicals R′ are carboxyl are advantageously readily dispersible in the application medium. In addition, the polymer can be modified at this reactive point, optionally only on the surface of the particles, in an application-oriented manner, e.g. by amidation or esterification.

The polymer may be linear and/or branched. It preferably includes no cyclic polymers. Branched polymers consist of linear repeat units and branching units, i.e. those repeat units of the formula I or II in which the aromatic backbone which is formed by A or A¹ and A² together with the carbon atoms to which they are bonded is substituted by at least one polymer chain which for its part contains repeat units of the formula I and/or II. Such polymers are also referred to as hyperbranched polymers.

The polymer is obtainable by polycondensation of compounds of the formula IV and/or V and VI 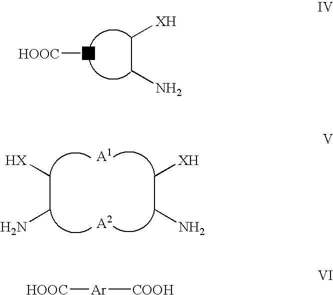
in which

X, A, A¹, A² and Ar have the meanings already given.

Particularly preferred compounds of the formula IV are 3-amino-2-hydroxybenzoic acid, 2-amino-3-hydroxybenzoic acid, 4-amino-3-hydroxybenzoic acid, 3-amino-4-hydroxybenzoic acid, 3-amino-2-mercaptobenzoic acid, 2-amino-3-mercaptobenzoic acid, 4-amino-3-mercaptobenzoic acid, 3-amino-4-mercaptobenzoic acid, 2,3-diaminobenzoic acid, 3,4-diaminobenzoic acid, 3-amino-2-hydroxy-1-naphthalenecarboxylic acid, 2-amino-3-hydroxy-1-naphthalenecarboxylic acid, 4-amino-3-hydroxy-1-naphthalenecarboxylic acid, 3-amino-4-hydroxy-1-naphthalenecarboxylic acid, 3-amino-2-mercapto-1-naphthalenecarboxylic acid, 2-amino-3-mercapto-1-naphthalenecarboxylic acid, 4-amino-3-mercapto-1-naphthalenecarboxylic acid, 3-amino-4-mercapto-1-naphthalenecarboxylic acid, 2,3-diamino-1-naphthalenecarboxylic acid, 3,4-diamino-1-naphthalenecarboxylic acid, 3-amino-4-hydroxy-2-naphthalenecarboxylic acid, 4-amino-3-hydroxy-2-naphthalenecarboxylic acid, 3-amino-4-mercapto-2-naphthalenecarboxylic acid, 4-amino-3-mercapto-2-naphthalenecarboxylic acid and 3,4-diamino-2-naphthalenecarboxylic acid. Very particular preference is given here to the hydroxy compounds.

Preferred polymers are obtainable by using at least partially a compound of the formula III 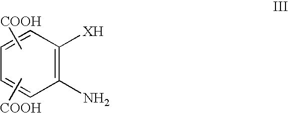
as compound of the formula IV.

In the formula III, X is preferably O. The two carboxyl groups are preferably not arranged in ortho position relative to one another. They are particularly preferably arranged in meta position relative to one another. In particular, a carboxyl group is arranged here in ortho position relative to the radical XH. A very particularly preferred compound of the formula III is 5-amino-4-hydroxyisophthalic acid.

In the polycondensation, the compound of the formula III is preferably used in an amount of at least 1 mol %, particularly preferably of at least 20 mol % and in particular of at least 30 mol %, based on the total amount of the compounds IV, V and VI used in the polycondensation.

Preferred compounds of the formula V are 4,6-diaminoresorcinol, 3,6-diaminohydroquinone, 4,4′-diamino-3,3′-dihydroxybiphenyl and 3,4′-diamino-3′,4-dihydroxybiphenyl.

Preferred compounds of the formula VI are phthalic acid, isophthalic acid, terephthalic acid, particular preference being given to terephthalic acid.

Optionally, it is possible to co-use diamines (except for those in which the amino groups are arranged in ortho position on an aromatic ring) and/or diols as chain extenders. These compounds effect the formation of ester and amide bonds in the polymer backbone. Suitable diamines are: hydrazine, N,N′-di(C₁-C₆-alkyl)-hydrazine, 1,6-hexanediamine, 1,5-pentanediamine, 1,4-butanediamine, 1,3-propanediamine, ethylenediamine, m- or p-phenylenediamine, 1,5-naphthyldiamine, 1,8-naphthyldiamine, 2,3-diaminonaphthalene, 3,3′-dihalo-4,4′-diaminodiphenyls, such as, for example, 3,3′-dichlorobenzidine, 4,4′-diaminodiphenyls, which may be substituted in the 3-, 3′-, 5- and/or 5′-position, 2,7-diaminofluorene, 4,4′-diaminodiphenylmethane, 4,4′-diaminodiphenyl ether, 4,4′-diaminodicyclohexylmethane, α,α′-diaminoxylenes, 1,4-diaminoanthraquinones, 4,4′-diaminobibenzyl, 4,4′-diaminobenzaniline, isophoronediamine or 1,3-bis(1-amino-1-methylethyl)benzene.

Suitable diols are: 1,2-ethanediol, 1,2-propanediol, 1,3-propanediol, 1,4-butanediol, 1,6-hexanediol, diisopropanolamine, N-methyldiethanolamine, neopentyl glycol, 1,12-dodecanediol, oligoalkylene glycols with 2 to 30 alkylene oxide units (e.g. ethylene oxide, propylene oxide and/or butylene oxide units), polytetrahydrofuran with 2 to 20 tetrahydrofuran units.

As chain terminators, it is possible to co-use monobasic aromatic carboxylic acids or o-amino(thio)phenols, o-phenylenediamines or their benzo-fused derivatives. Suitable chain terminators are benzoic acid, 1-aminophenol, 1-aminomercaptobenzene, o-phenylenediamine, 1-amino-2-naphthol, 2-amino-1-naphthol, 2-amino-3-naphthol, 3-amino-2-naphthol, 1-amino-2-naphthalene-thiol, 2-amino-1-naphthalenethiol, 2-amino-3-naphthalenethiol, 3-amino-2-naphthalenethiol, 1,2-diaminonaphthalene and 2,3-diaminonaphthalene.

As further chain terminators, it is possible to use monoalcohols and monoamines with which the polymer or the surface of the particles can optionally be modified in an application-oriented manner; such as ammonia and primary and secondary alkylamines such as, for example, methylamine, dimethylamine, ethylamine, diethylamine, propylamine, butylamine, hexylamine, 2-ethylhexoxypropylamine, cyclohexylamine, aminated alkyl-capped polyalkylene oxides of the type H₂N-(AO)ₙ—O-alkyl (where n is 2 to 30, AO is ethylene oxide, propylene oxide or n-butylene oxide, alkyl is preferably C₁-C₄-alkyl), dodecylamine, octadecylamine, laurylamine, ethanolamine, diethanolamine, aniline, 1-naphthylamine, 2-naphthylamine, morpholine, isopropanolamine, and the alcohols n-butyl glycol, butanol, pentanol, hexanol, 2-ethylhexanol, octanol, decanol, dodecanol, octadecanol, alkyl-capped polyalkylene oxides of the type HO-(AO)ₙ—O-alkyl (where n is 2 to 30, AO is ethylene oxide, propylene oxide or butylene oxide, alkyl is preferably C₁-C₄-alkyl), benzyl alcohol, phenol, substituted phenols.

The sum of chain extenders and chain terminators is preferably at most 50 mol %, based on the sum of the compounds of the formula IV, V, VI and chain extenders and chain terminators. The chain extenders are used in particular in an amount of at most 15 mol %, particularly preferably at most 10 mol %.

The present invention further provides a process for the preparation of a UV absorber by polycondensation of compounds of the formula IV and/or V and/or VI 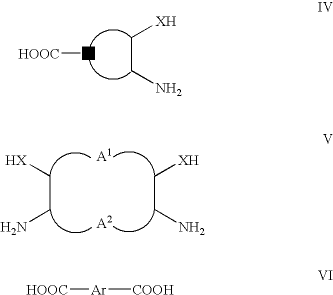
in which

X, A, A¹, A² and Ar have the meanings already given, and subsequent comminution of the resulting polymer.

The compounds of the formula IV used are preferably at least partially a compound of the formula III

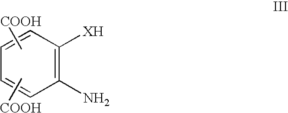

With regard to the preferred compounds III, IV, V and VI used, and the possibility of co-using chain extenders and chain terminators, that stated above is applicable.

The polycondensation is preferably carried out in the presence of water-withdrawing agents, such as polyphosphoric acid, optionally in the presence of phosphorus pentoxide, phosphoric acid, sulfuric acid, thionyl chloride and carbodiimides. Particular preference is given to using polyphosphoric acid in the presence of phosphorus pentoxide.

The polycondensation can be carried out in solvents or without solvents. If solvents are used, then these are preferably chosen from high-boiling solvents, such as dimethylformamide (DMF) or N-methylpyrrolid-2-one (NMP). If polyphosphoric acid is used as a water-withdrawing agent, then the process is preferably carried out without a solvent.

The polycondensation is preferably carried out at a temperature in the range from 150 to 250° C., particularly preferably from 150 to 220° C., in particular from 170 to 200° C.

The polycondensation is preferably carried out under an inert gas atmosphere, for example under a nitrogen or argon atmosphere.

The polycondensation product is isolated in the customary manner, for example by precipitating out the reaction product in an aqueous medium and subsequently drying it, or by removing the solvent and the water-withdrawing agent, for example by decantation or by distillation.

The essentially water- and solvent-free polycondensation product cannot usually be melted without decomposition. The decomposition point is at least 350° C., particularly preferably at least 450° C. and in particular at least 500° C.

The subsequent comminution of the polycondensation product is carried out in accordance with customary processes known to the person skilled in the art, for example by grinding in a bead mill, vibratory mill, planetary mill or in a kneader. The comminution can also take place at the same time as dispersion in the application medium. It is, however, also possible to prepare a concentrate or a masterbatch by dispersing the polymer in a small amount of the application medium, one of its components or a medium compatible therewith.

The present invention further provides for the use of the UV absorber according to the invention for the stabilization of inanimate organic materials against the action of light. Organic materials which can be stabilized in this way are, for example, molding compositions, such as polyolefins, polyesters, polyamides, polyurethanes, polycarbonates or impact-modified polystyrenes, such as ABS, and mixtures thereof, and also coating films, such as lacquer coatings, in particular varnishes. The UV absorber according to the invention is for this purpose finely dispersed in the respective application medium, the method of dispersion being determined by the application medium in question. To stabilize coating films, the UV stabilizer is incorporated into the coating formulation which, following application, e.g. by brushing, spraying or printing processes, and drying and/or curing, produces the coating film.

The UV absorber is incorporated into the application medium by, for example, shaking, beating, stirring, turbulent mixing, vibrations and cavitation, e.g. by means of ultrasound and other customary dispersion techniques. For this, dynamic or static systems are used, e.g. shaking units, mixing vessels, stirring mills, roller mills, rotor-stator systems, toothed dispersing machines, ultrasound homogenizers, jet dispersers, shear gap mixers and other systems which are known to the person skilled in the art.

If the UV stabilizer according to the invention is used in molding compositions, the stabilizer or a concentrate or masterbatch is incorporated into the molding composition present in polymeric form usually by rolling in, preferably at elevated temperatures.

Alternatively, the UV absorber according to the invention can be incorporated into molding compositions by, prior to polymerization of the monomers which form the basis of the molding composition, distributing it into said monomers in accordance with the abovementioned dispersion processes, and then polymerizing the mixture.

The UV stabilizer according to the invention can be readily dispersed in common application media, where it advantageously does not scatter incident light. In addition, it is not soluble in the application media, which results in positive migration behavior, i.e. the stabilizer migrates neither into nor out of the application medium. This in turn ensures a long-lasting UV protection of the application media provided with the UV stabilizer according to the invention, and manufacturing products thereof.

The invention further provides for the use of the UV absorber according to the invention as a light protection factor in cosmetic formulations, such as sunscreens, lipsticks, sunblocks and the like. The cosmetic formulations comprise the UV absorber and optionally cosmetically active active ingredients in a cosmetically acceptable carrier.

The carrier is chosen, for example, from water, water-miscible liquids, hydrophobic components and mixtures. These include water, C₁-C₄-alcohols, such as ethanol and isopropanol, fats, waxes, fatty acids, fatty alcohols, oils, oil-in-water and water-in-oil emulsions, creams and pastes, lip protection stick compositions or fat-free gels.

Suitable emulsions are, inter alia, also O/W macroemulsions, O/W microemulsions or O/W/O emulsions, where the emulsions are obtainable by phase inversion technology, e.g. in accordance with DE-A-197 26 121.

The hydrophobic component (lipid phase) can be chosen advantageously from the following group of substances:
mineral oils, mineral waxes
oils, such as triglycerides of capric or of caprylic acid, but preferably castor oil;
fats, waxes and other natural and synthetic fatty bodies, preferably esters of fatty acids with alcohols of low carbon number, e.g. isopropanol, propylene glycol or glycerol, or esters of fatty alcohols with alkanoic acids of low carbon number or with fatty acids; alkyl benzoates;
silicone oils, such as dimethylpolysiloxanes, diethylpolysiloxanes, diphenylpolysiloxanes, and mixed forms thereof.

The oil phase is advantageously chosen from the group of esters of saturated and/or unsaturated, branched and/or unbranched allkanecarboxylic acids of chain length of from 3 to 30 carbon atoms from the group of esters of aromatic carboxylic acids and saturated and/or unsaturated, branched and/or unbranched alcohols of chain length of from 3 to 30 carbon atoms. Such ester oils can advantageously be chosen from the group consisting of isopropyl myristate, isopropyl palmitate, isopropyl stearate, isopropyl oleate, n-butyl stearate, N-hexyl laurate, N-decyl oleate, isooctyl stearate, isononyl stearate, isononyl isononanoale, 2-ethylhexyl palmitate, 2-ethylhexyl laurate, 2-hexyldecyl stearate, 2-octyldodecyl palmitate, 2-ethylhexyl laurate, 2-hexyldecyl stearate, 2-octyldodecyl palmitate, oleyl oleate, oleyl erucate, erucyl oleate, erucyl erucate, and synthetic, semisynthetic and natural mixtures of such esters, e.g. jojoba oil.

In addition, the oil phase can advantageously be chosen from the group of branched and unbranched hydrocarbons and hydrocarbon waxes, the silicone oils, the dialkyl ethers, the group of saturated or unsaturated, branched or unbranched alcohols, and the fatty acid triglycerides, namely the triglycerol esters of saturated and/or unsaturated, branched and/or unbranched alkanecarboxylic acids having a chain length of from 8 to 24, in particular 12 to 18, carbon atoms. The fatty acid triglycerides can be chosen advantageously, for example, from the group of synthetic, semisynthetic and natural oils, e.g. olive oil, sunflower oil, soybean oil, peanut oil, rapeseed oil, almond oil, palm oil, coconut oil, palm kernel oil and the like.

The aqueous phase of the preparation according to the invention optionally advantageously comprises:
alcohols, diols or polyols of low carbon number, and ethers thereof, preferably ethanol, isopropanol, propylene glycol, glycerol, ethylene glycol, ethylene glycol monoethyl or monobutyl ether, propylene glycol monomethyl, monoethyl or monobutyl ether, diethylene glycol monomethyl or monoethyl ether and analogous products.

The cosmetic formulations can comprise cosmetic auxiliaries. Customary cosmetic auxiliaries which may be suitable as additives are, for example, coemulsifiers, stabilizers, thickeners, biogenic active ingredients, film formers, fragrances, dyes, pearlizing agents, preservatives, pigments, electrolytes (e.g. magnesium sulfate), insect repellents and pH regulators. Suitable coemulsifiers are preferably known W/O and also O/W emulsifiers, such as, for example, polyglycerol esters, sorbitan esters or partially esterified glycerides. Stabilizers which can be used are metal salts of fatty acids, such as, for example, magnesium stearate, aluminum stearate and/or zinc stearate. Suitable thickeners are, for example, crosslinked polyacrylic acids and derivatives thereof, polysaccharides, in particular xanthan gum, guarguar, agaragar, alginates and Tyloses, carboxymethylcellulose and hydroxyethylcellulose, and also fatty alcohols, monoglycerides and fatty acids, polyacrylates, polyvinyl alcohol and polyvinylpyrrolidone. Biogenic active ingredients are understood as meaning, for example, plant extracts, protein hydrolysates and vitamin complexes. Customary film formers are, for example, hydrocolloids, such as chitosan, microcrystalline chitosan or quaternized chitosan, polyvinylpyrrolidone, vinylpyrrolidone-vinyl acetate copolymers, polymers of the acrylic acid series, quaternary cellulose derivatives and similar compounds. Suitable preservatives are, for example, formaldehyde solution, p-hydroxybenzoate or sorbic acid. Suitable pearlizing agents are, for example, glycol distearic esters, such as ethylene glycol distearate, but also fatty acids and fatty acid monoglycol esters. Dyes which can be used are the substances approved and suitable for cosmetic purposes, as are listed, for example, in the publication “Kosmetische Farbemittel” [Cosmetic Colorants] from the Farbstoffkommission der Deutschen Forschungsgemeinschaft [Dyes Commission of the German Research Society], published by Verlag Chemie, Weinheim, 1984. These dyes are usually used in a concentration of from 0.001 to 0.1% by weight, based on the total mixture.

The cosmetic formulation can additionally also comprise at least one insect repellent. These include, for example, 2-ethyl-1,3-hexanediol, 2-ethyl-2,3-hexanediol, 4,5-bis(2-butylene)tetrahydro-2-furaldehyde, dimethyl phthalate, di-n-propyl isocinchomeronate and N,N,-diethyl-m-toluamide.

An additional content of antioxidants is generally preferred. According to the invention, favorable antioxidants which can be used are all antioxidants customary or suitable for cosmetic and/or dermatological applications.

Advantageously, the antioxidants are chosen from the group consisting of amino acids (e.g. glycine, histidine, tyrosine, tryptophan) and derivatives thereof, imidazoles (e.g. urocanic acid) and derivatives thereof, peptides, such as D,L-carnosine, D-carnosine, L-carnosine and derivatives thereof (e.g. anserine), carotenoids, carotenes (e.g. β-carotene, lycopene) and derivatives thereof, chlorogenic acid and derivatives thereof, lipoic acid and derivatives thereof (e.g. dihydrolipoic acid), aurothioglucose, propylthiouracil and other thiols (e.g. thiorodoxin, glutathione, cysteine, cystine, cystamine and the glycosyl, N-acetyl, methyl, ethyl, propyl, amyl, butyl and lauryl, palmitoyl, oleyl, γ-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g. buthioninesulfoximines, homocysteinesulfoximines, buthionine sulfones, penta-, hexa-, heptathionine sulfoximine) in very low tolerated doses (e.g. pmol to μmol/kg), and also (metal) chelating agents (e.g. α-hydroxy fatty acids, palmitic acid, phytic acid, lactoferrin), α-hydroxy acids (e.g. citric acid, lactic acid, malic acid), humic acid, bile acid, bile extracts, biliburin, biliverdin, EDTA and derivatives thereof, unsaturated fatty acids and derivatives thereof (e.g. γ-linolenic acid, linoleic acid, oleic acid), folic acid and derivatives thereof, ubiquinone and ubiquinol and derivatives thereof, vitamin C and derivatives thereof (e.g. ascorbyl palmitate, Mg ascorbyl phosphate, ascorbyl acetate), tocopherol and derivatives (e.g. vitamin E acetate, tocotrienol), vitamin A and derivatives (vitamin A palmitate), and coniferyl benzoate of benzoin resin, rutinic acid and derivatives thereof, α-glycosylrutin, ferulic acid, furfurylideneglucitol, carnosine, butylhydroxytoluene, butylhydroxyanisole, nordihydroguaicic acid, nordihydroguaiaretic acid, trihydroxybutyrophenone, uric acid and derivatives thereof, mannose and derivatives thereof, zinc and derivatives thereof (e.g. ZnO, ZnSO₄), selenium and derivatives thereof (e.g. selenium methionine), stilbenes and derivatives thereof (e.g. stilbene oxide, trans-stilbene oxide).

The examples below serve to explain the invention, but without limiting it thereto.

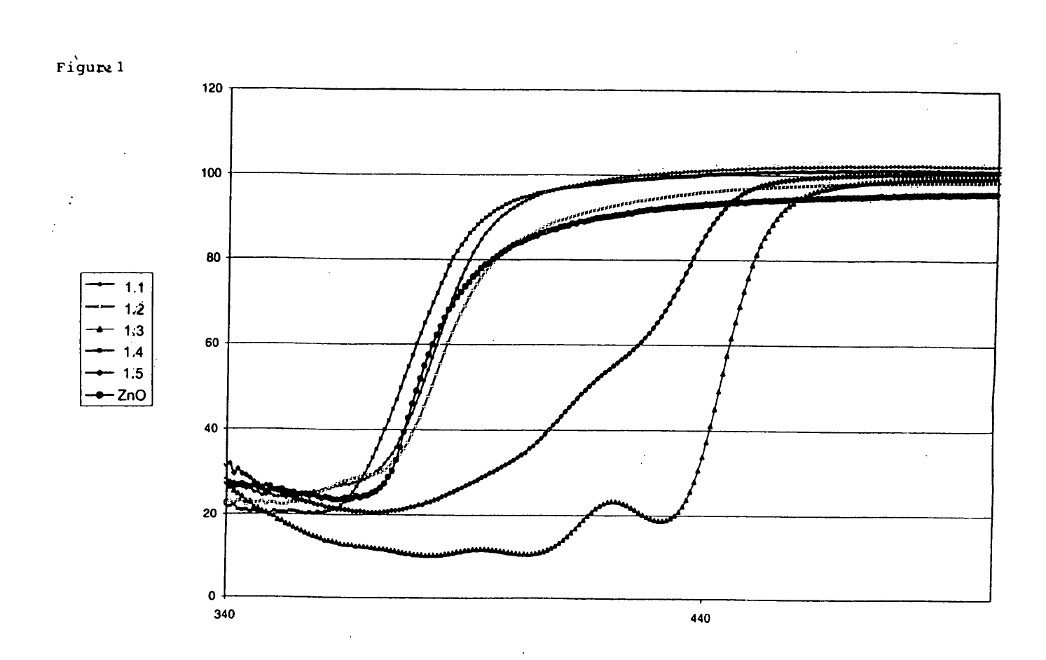

FIG. 1 shows the UV/VIS transmission spectra of polyurethane lacquer films in the wavelength range from 340 to 500 nm which contain inventive polycondensation products and a commercially available UV-absorber based on zinc oxide, respectively.

### 1. PREPARATION EXAMPLES

5-Amino-4-hydroxyisophthalic acid can be prepared by the process described by S. E. Hunt, J. I. Jones, A. S. Lindsey, J. Chem. Soc. 1956, 3099-3107.

### 1.1. Polycondensation of 5-amino-4-hydroxyisophthalic acid

550 g of polyphosphoric acid were heated to 180° C. and 20.0 g of 5-amino-4-hydroxyisophthalic acid were slowly added thereto. The dark-green mixture was stirred at this temperature for 24 h. The reaction mixture was then cooled to 140° C. and slowly added to 1.51 of ice-water. The black suspension which formed was stirred for a further 30 min and finally filtered. The filtercake was afterwashed with water until the washing water, which ran off colorless, had a conductivity of less than 10 μS.

### 1.2 Polycondensation of 5-amino-4-hydroxyisophthalic acid and o-aminophenol

550 g of polyphosphoric acid were heated to 180° C., and a mixture of 10.0 g (0.05 mol) of 5-amino-4-hydroxyisophthalic acid and 5.5 g (0.05 mol) of o-aminophenol was added slowly thereto at this temperature, and the dark-green mixture was stirred at this temperature for 24 h. The reaction mixture was then cooled to 140° C. and slowly added to 1.51 of ice-water. The black suspension which formed was stirred for a further 30 min and finally filtered. The filtercake was afterwashed with water until the washing water, which ran off colorless, had a conductivity of less than 10 μS.

### 1.3 Polycondensation of 4-amino-3-hydroxybenzoic acid

Performed similarly to Example 1.1.

### 1.4 Polycondensation of 5-amino-4-hydroxyisophthalic acid and 3-amino-4-hydroxybenzoic acid

Performed similarly to Example 1.2.

### 1.5 Polycondensation of 5-amino-4-hydroxyisophthalic acid and 4-amino-3-hydroxybenzoic acid

Performed similarly to Example 1.2.

The table which follows summarises monomers used, yields, solids contents of filtercakes and melting points of polycondensation products (determined by differential thermal analysis).

| | | Yield | Melting point | Solids content |
|---|---|---|---|---|
| Ex. | Monomer | [%] | [C. °] | [%] |
| 1.1 | AHIT | 95 | 520 | 7.9 |
| 1.2 | AHIT/o-AP | 88 | 583 (dec.) | 9.5 |
| | 1/1 | | | |
| 1.3 | 4A3HBS | 92 | n.d. | 8.4 |
| 1.4 | AHIT/3A4HBS | 100 | n.d. | 8.9 |
| | 1/1 | | | |
| 1.5 | AHIT/4A3HBS | 93 | n.d. | 8.0 |
| | 1/1 | | | |

AHIT = 5-amino-4-hydroxyisophthalic acid
o-AP = ortho-aminophenol
4A3HBS = 4-amino-3-hydroxybenzoic acid
3A4HBS = 3-amino-4-hydroxybenzoic acid
n.d. = not determined

### 2. APPLICATION EXAMPLES

### 2.1 Stabilization of Lacquers

An Example 1.1 to 1.5 filtercake quantity corresponding to 100 mg of polycondensation product (see table for solids content of filtercake) was shaken together with 5 g of a water-based coating in a 40 ml glass bottle with 10 g of SAZ beads (silicon oxide-aluminum oxide-zirconium oxide beads) for 16 h in a Skandex shaking unit. The paste obtained in the process was then dispersed in a further 5 g of the water-based coating by shaking for 5 minutes in a Skandex shaking unit. The water-based coating used had a solids content of 21% by weight and contained a polyurethane dispersion and a melamine crosslinker. The UV-stabilizer-coating dispersion was applied to an acetate film using a doctor blade. The coated film obtained in this process was then flashed off for 30 min and finally thermally treated for 30 min at 130° C. The layer thickness of the dry coating was about 5 μm. The coated acetate film did not have any agglomerates which were visible to the eye. In addition, incident light was not scattered. The UV/VIS spectra in FIG. 1 show that the film coated in this way absorbed more than 80% of UV-A radiation (below 360 nm), while it was virtually translucent for light in the visible spectral region. In a TEM (transmission electron microscopy) section prepared at low temperature of the films prepared in this way, particles approximately 50 nm in size can be seen.

For comparison, the above procedure was repeated using 0.1 g of UV-absorber based on zinc oxide (BET surface area 16 m²/g, primary particle size (TEM) 20 to 100 nm). The film obtained in this way absorbed in the same spectral region, but incident light was scattered to a more considerable extent visible to the eye than in the case of the use of the polycondensation products according to the invention. This scattering could be seen particularly against a black background which appeared whiter in the case of the zinc oxide.

### 2.2. Investigation of the Migration Behavior in Polyethylene

A rolled sheet with a thickness of 400 μm was prepared from 69.3 g of an LDPE (Basell, MFI=0.5, d=0.918 g/cm³) and 0.07 g (dry weight) of the polycondensation product from 1.1 on a calender roll (Collin 1150) at 160° C. and 200 revolutions for 6 min. This predispersed material was then dispersed 7× at room temperature on a calendering device (Schwabentherm). It was then rolled on the calender roll (Collin 1150) at 160° C. and 100 revolutions to give a rolled sheet of thickness 400 μm. Finally, the rolled sheet was pressed at 180° C. with a steaming press (Wickert) between two pressing plates to a thickness of 1 mm. The resulting film was stored for 72 h at 50° C. and then wiped with a fabric cloth. The wiped film was analyzed by means of UV/VIS spectroscopy and compared with UV/VIS spectra of films which had not been thermally treated. The comparison shows that the UV/VIS spectra of the thermally treated and untreated films do not differ, i.e. the UV stabilizer did not migrate out of the film.

The above procedure was repeated using 0.07 g of the polycondensation product from 1.2. Here too, the UV/VIS spectra of the thermally treated films showed no difference to the UV/VIS spectra of untreated films. Thus, the UV stabilizer did not migrate out of the polyethylene film here either.

### 2.3 Use of Polycondensation Products in a Cosmetic Formulation

8.00 g of dibutyl adipate (Cetiol b, from Cognis), 8.00 g of C₁₂-C₁₅-alkyl benzoate, 12.00 g of cocoglyceride (Myritol 331, from CA Erbslöh), 1.00 g of sodium cetearyl sulfate (Lanette E, from Cognis) and 4.00 g laurylglucoside Cognis), 2.00 g of cetearyl alcohol (Lanette 0) and 1.00 g of vitamin E acetate (BASF) and 3.00 g ethylhexyltriazone (Uvinul T150 BASF) were homogenized at 80° C. Thereafter, 50.6 g of filtercake from Example 1.1 (corresponding to 4.0 g of polycondensation product, 46.6 g of H₂O), 42.1 g of filtercake from Example 1.2 (4.0 g of polycondensation product, 38.1 g of H₂O), 47.6 g of filtercake from Example 1.3 (4.0 g of polycondensation product, 43.6 g of H₂O), 44.9 g of filtercake from Example 1.4 (4.0 g of polycondensation product, 40.9 g of of H₂O) 50.0 g of filtercake from Example 1.5 (4.0 g of polycondensation product, 46.0 g of H₂O) or 4.0 g of a UV-absorber based on zinc oxide (BET surface area 16 m²/g, primary particle size (TEM) 20 to 100 nm) were added at this temperature and dispersed with an Ultrathurax homogenizer for 3 minutes.

To this dispersion was added a hot dispersion at 80° C. obtained by homogenizing 3.00 g of glycerol, 0.05 g of EDTA sodium salt, 0.20 g of allantoin, 0.30 g of xanthan gum (Keltrol, from Kleco), 1.50 g of magnesium aluminosilicate (Veegum Ultra, from Vanderbilt) and an amount of distilled water (which was 50.45 g in the case of the zinc oxide UV-absorber and was reduced by the water content of the filtercakes (see above) in the case of the inventive polycondensation products) at 80° C.

The combined dispersions were cooled down to 40° C. and admixed with 0.50 g of citric acid, if desired scents and 1.00 g of a mixture of phenoxyethanol and alkylparabens (Phenonip, from Nipa).

The formulation obtained can be used as suncream. The formulations which contained the inventive polycondensation products have for the same layer thickness a similar absorption spectrum, but are less white-scattering than the zinc oxide formulation, and this provides esthetic advantages in the case of dark-pigmented skin in particular.

1. A UV absorber for stabilizing inanimate organic materials against the action of light, the uv absorber comprising a finely divided polymer with a volume-average particle size of from 5 to 1000 nm which contains repeat units of the formula I and/or II 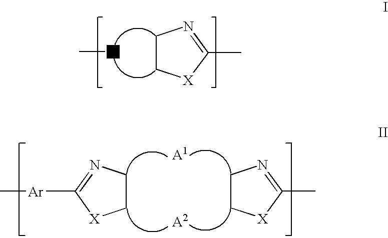
in which
x is NH, O or S,
A or A¹ and A² together with the carbon atoms to which they are bonded form an aromatic backbone with one to three fused benzene rings or a diaryl backbone which can carry one to three substituents chosen from carboxyl, alkyl, alkenyl, aryl, alkylaryl, alkoxy, halogen or nitro, or a polymer chain containing repeat units of the formula I and/or II,
Ar is a divalent aromatic radical with one to three fused benzene rings or a diaryl radical which can carry one to three substituents chosen from carboxyl, alkyl, alkenyl, aryl, alkylaryl, alkoxy, halogen or nitro:

2. The use UV absorber as claimed in claim 1, where the polymer is obtained by polycondensation of compounds of the formula IV and optionally V and VI, 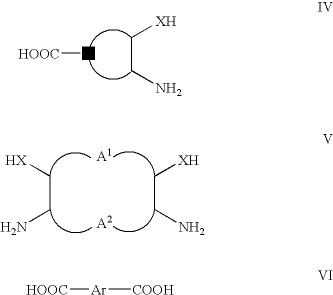
in which,
X, A, A¹, A² and Ar are as defined in claim 1, and the compound of the formula IV used is at least partially a compound of the formula III

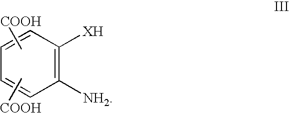

3. The UV absorber as claimed in claim 2, where the compound of the formula III is 5-amino-4-hydroxyisophthalic acid.

4. The UV absorber as claimed in claim 2, where the compound of the formula III is used in an amount of at least 1 mol %, based on the total amount of the compounds IV, V and VI.

5. The UV absorber as claimed in claim 2, where the chain extenders co-used are diamines and/or diols and/or the chain terminators used are monobasic aromatic carboxylic acids, o-amino(thio)phenols, o-phenylenediamines, monohydric alcohols and/or monoamines.

6. The UV absorber as claimed in claim 1, where the inanimate organic material is a molding composition 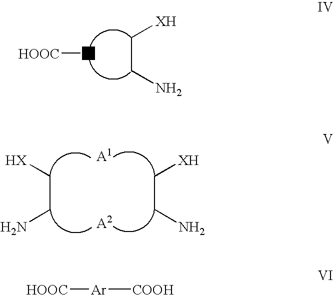
in which
X, A, A¹, A² and Ar are as defined in claim 1,
and subsequent comminution of the resulting polymer to a volume-average particle size of from 5 to 1000 nm.

7. The use UV absorber as claimed in claim 6, where the molding composition is a polyolefin, polyester, polyamide, polyurethane, polycarbonate, impact-modified polystyrene or a mixture thereof.

8. The UV absorber as claimed in claim 1, where the inanimate organic material is a coating film.

9. A cosmetic formulation comprising the UV absorber as defined in claim 1 as a light protection factor.

10. A UV absorber comprising a finely divided polymer with a volume-average particle size of from 5 to 1 000 nm which contains repeat units of the formula I and/or II 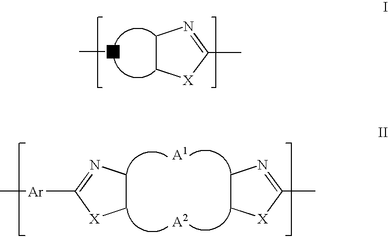
in which
x is NH, O or S,
A or A¹ and A² together with the carbon atoms to which they are bonded form an aromatic backbone with one to three fused benzene rings or a diaryl backbone which can carry one to three substituents chosen from carboxyl, alkyl, alkenyl, aryl, alkylaryl, alkoxy, halogen or nitro, or a polymer chain containing repeat units of the formula I and/or II,
Ar is a divalent aromatic radical with one to three fused benzene rings or a diaryl radical which can carry one to three substituents chosen from carboxyl, alkyl, alkenyl, aryl, alkylaryl, alkoxy, halogen or nitro
the polymer being obtainable obtained by polycondensation of compounds of the formula IV and if appropriate V and VI, 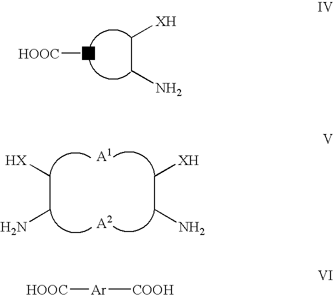
and a compound of the formula Ill 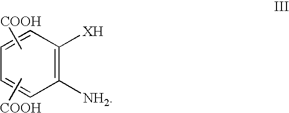
being at least partially used as compound of the formula IV.

11. A UV absorber as claimed in claim 10, where the compound of the formula III is 5-amino-4-hydroxyisophthalic acid.

12. A UV absorber as claimed in claim 10, where the compound of the formula III is used in an amount of at least 1 mol %, based on the total amount of the compounds IV, V and VI.

13. A UV absorber as claimed in claim 10, where the chain extenders co-used are diamines and/or diols and/or the chain terminators used are monobasic aromatic carboxylic acids, o-amino(thio)phenols, o-phenylenediamines, monohydric alcohols and/or monoamines.

14. A process for the preparation of a UV-absorber as claimed in claim 10 by polycondensation of compounds of the formula IV and/or V and/or VI 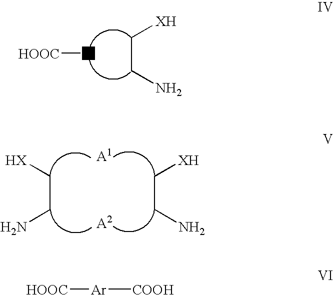
in which
X, A, A¹, A² and Ar are as defined in claim 10.

15. A coating preparation comprising a UV absorber as claimed in claim 10.

16. A cosmetic formulation comprising a UV absorber as claimed in claim 10 and optionally cosmetically active active ingredients in a cosmetically acceptable carrier.

17. A molding composition comprising a UV absorber as claimed in claim 10.

18. A method for stabilizing an inanimate organic material against the action of light, said method comprising applying the UV absorber of claim 1 to the material.

19. A method for protecting skin from UV radiation, said method comprising applying the UV absorber of claim 10 to the skin.
